(19) United States
(12) Patent Application Publication
(10) Pub. No.: US 2015/0157918 A1
(43) Pub. Date: Jun. 11, 2015

(54) Systems And Methods For Muscular Development

(71) Applicant: Ryan Tracy, Denver, CO (US)

(72) Inventor: Ryan Tracy, Denver, CO (US)

(21) Appl. No.: 14/101,183

(22) Filed: Dec. 9, 2013

(51) Int. Cl. A63B 71/06; H04W 4/00; G06Q 20/22; G06F 17/30; G06F 3/0481

(52) U.S. Cl. CPC A63B 71/06; G06F 17/30867; G06F 3/04817; G06F 3/04815; G06Q 20/223; H04W 4/005

(57) ABSTRACT

Systems and methods for muscular development are disclosed. Various embodiments generally relate to devices and techniques for providing stimulus to the human body over time to achieve dramatic results in neuromuscular coordination, strength, endurance, rehabilitation, recovery, and/or muscle hypertrophy. Some embodiments provide for mobile applications and/or exercise devices that teach users how to manipulate smaller muscles to compound the effect on the larger muscles.

### TECHNICAL FIELD

Various embodiments generally relate to systems and methods for providing muscular development. More specifically, some embodiments relate to systems and techniques for providing stimulus to the human body over time to achieve dramatic results in neuromuscular coordination, strength, endurance, and/or muscle hypertrophy.

### BACKGROUND

Health and physical conditioning improves longevity and the quality of life for individuals. Many individuals purchase gym memberships, exercise videos, and exercise devices (e.g., treadmill and stair climbing machines) to improve their health and physical conditioning. Unfortunately, these items are not without some challenges of their own. For example, the repetitive nature of the exercises and exercise routines associated with exercise videos and exercise devices can create a lack of motivation. In addition, ensuring proper form for each exercise and exercise routine can be difficult. Improper form can lead to injuries, thus defeating the purpose of the activity. As such, there is a need for improved exercise devices and routines to help individuals improve their health and physical conditioning.

### BRIEF DESCRIPTION OF THE DRAWINGS

Embodiments of the present invention will be described and explained through the use of the accompanying drawings in which:

FIG. 1 illustrates an example of an networked-based environment;

FIG. 2 illustrates a set of components in a muscular development marketplace;

FIG. 3 illustrates a set of components in an exercise device;

FIG. 4 is a flowchart illustrating a set of operations for identifying and retrieving an exercise routine based on subscription levels and target areas;

FIG. 5 is a flowchart illustrating a set of operations for developing a training plan;

FIG. 6 illustrates a graphical user interface which may be used;

FIGS. 7-9 illustrate the use of an upper body exercise device;

FIG. 10 illustrates a shirt which may be used to position an upper body exercise device;

FIGS. 11-12 illustrate a lower body exercise device which may be used;

FIG. 13 illustrates a pair of pants which may be used to position a lower body exercise;

FIG. 14 illustrates an arm covering which may be used;

FIG. 15 illustrates a leg covering which may be used;

FIGS. 16A-16C illustrate a chair which may be used;

FIG. 17 illustrates an exercise device which may be used;

FIG. 18 illustrates an exercise device which may be used;

FIG. 19 illustrates a shoe which may be used; and

FIG. 20 illustrates an example of a computer system.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments generally relate to systems and methods for providing muscular development. More specifically, some embodiments relate to systems and techniques for providing stimulus to the human body over time to achieve dramatic results in neuromuscular coordination, strength, endurance, rehabilitation, recovery, and/or muscle hypertrophy. Various embodiments provide for mobile applications and/or exercise devices that teach users how to manipulate smaller muscles to compound the effect on the larger muscles. For example, in some embodiments, a muscular development marketplace can electronically send a training plan to a user that includes a series of exercises and/or movement patterns the user should do for the day. The training plan can be generic or customized based on a set of user objectives, desired style of workout, membership level, available exercise devices, and/or other inputs.

In some embodiments, current performance results that were recorded at an exercise device can be communicated to the muscular development marketplace. The performance results may include an identifier associated with a particular user. Historical performance results and a set of client objectives associated with the user can be retrieved from a database (e.g., using the identifier). Both the historical and current performance results can be analyzed and used in generating a training plan for the user designed to meet the set of client objectives. The training plan may be for a single workout or may include multiple workouts.

Once generated, the training plan can be communicated to the user through graphical user interface and/or directly to an exercise device. In some embodiments, the training plan may identify exercises and/or movement patterns, length of time to perform each exercise or movement pattern, motivational quotations, music files to help motivate or relax the user, video files (e.g., to teach proper form), and/or other components. The exercise devices can record the activity (i.e., the user's attempt to perform the exercise). These records may include times, dates, success rates, strength metrics, endurance metrics, and/or other information which can be transmitted back to the muscular development marketplace. Using these inputs, the muscular development marketplace can modify the training plan if needed.

The exercises included in the training plan can include traditional exercises and/or small movement exercises designed to manipulate the smaller muscles to compound the effect on the larger muscles. In some embodiments, the smaller the motion, the greater the compounding effect on the targeted muscles. These exercises can include variations and angles that allow the user to target and manipulate different muscles and muscle combinations. For example, one such small movement exercise designed to target the bottom of a user's abs places the user in a standing position while pressing their toes in a unique pattern while activating the abs. As such, the user is directed to stand still and contract their abs while pressing down with their left toes, pressing down with their right toes, pressing down with their left toes, etc. As a variation, the user's may also raise and lower their heels in order to activate different portions of the abs.

Another example of a small movement exercise designed to target various areas of the forearms includes flexing the hand at the wrist (e.g., downward) moving the fingers. In order to work biceps with the small movement exercises, a user may extend their arm outright (i.e., parallel to the floor) and bend their arms at the elbow to create a right angle (or almost right angle). While keeping these joints in the bent position, the user may open and shut their fingers in a small movement pattern. By purposefully contracting and flexing the entire length of their fingers, the user is able to maximize impact on the biceps.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Moreover, the techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical discs, compact disc read-only memories (CD-ROMs), magneto-optical discs, ROMs, random access memories (RAMs), erasable programmable read-only memories (EPROMs), electrically erasable programmable read-only memories (EEPROMs), application-specific integrated circuits (ASICs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean the particular feature, structure, or characteristic following the phrase is included in at least one implementation of the present invention, and may be included in more than one implementation. In addition, such phrases do not necessarily refer to the same embodiments or different embodiments.

The term “module” or “engine” refers broadly to general or specific-purpose hardware, software, or firmware (or any combination thereof) components. Modules and engines are typically functional components that can generate useful data or other output using specified input(s). A module or engine may or may not be self-contained. Depending upon implementation-specific or other considerations, the modules or engines may be centralized or functionally distributed. An application program (also called an “application”) may include one or more modules and/or engines, or a module and/or engine can include one or more application programs.

### General Description

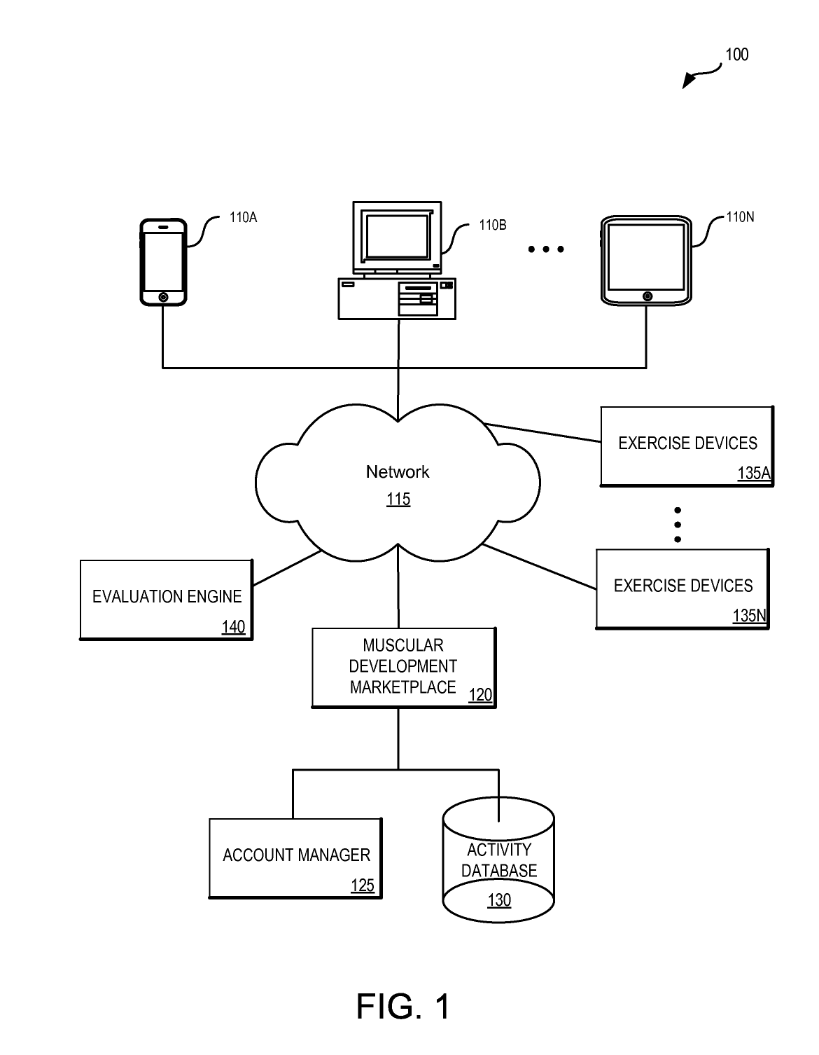

FIG. 1 illustrates an example of a network-based environment in which some embodiments of the present invention may be utilized. The embodiments illustrated in FIG. 1 show computing devices 110A-110N that can be any computing device capable of receiving user input as well as transmitting and/or receiving data via the network 115. In one embodiment, computing device 110A-110N may be a conventional computer system (e.g., a desktop or laptop computer), a tablet computer, or a mobile device having computer functionality (e.g., a mobile telephone or a smart-phone). Computing devices 110A-110N may be configured to use network 115 to communicate with muscular development marketplace 120. In some embodiments, computing devices 110A-110N can retrieve or submit information to muscular development marketplace 120 and run one or more applications for interacting with a user. For example, computing devices 110A-110N can execute a browser application or a customized client to enable interaction between the computing devices 110A-110N and muscular development marketplace 120.

Network 115 can include any combination of local area and/or wide area networks, using both wired and wireless communication systems. In one embodiment, network 115 uses standard communications technologies and/or protocols. Thus, network 115 may include links using technologies such as Ethernet, 802.11, worldwide interoperability for microwave access (WiMAX), 3G, 4G, CDMA, digital subscriber line (DSL), etc. Similarly, the networking protocols used on network 115 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 115 may be represented using technologies and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

Muscular development marketplace 120 can be used to generate, manage, execute, distribute, and/or record customized training plans based on information received through various interfaces. In some embodiments, muscular development marketplace 120 can include various data processing and analytic tools that allow for implementation, creation, and evaluation of customer objectives, performance results, and customized training plans. Muscular development marketplace 120 may receive, through an application running on computing device 110A-110N, inputs about which muscles a user wants to work. In some embodiments, the application may prompt the user with a series of questions, or provide another selection mechanism (e.g., a visual body display) to allow the user to set which body parts they want to work (e.g., biceps). The questions and/or other selection mechanisms may be interactive and may recognize and prompt a user who may want a different solution or objective (e.g., did the user mean biceps or did they really mean arms including biceps and triceps?).

Muscular development marketplace 120 may have multiple membership levels. These membership levels may be free or may require a fee. Account manager 125 can manage the membership status, send reminders of payments, process auto payments, and the like for muscular development marketplace 120. The membership level (e.g., free, bronze, silver, gold, platinum, and diamond) may allow the user of muscular development marketplace 120 access to different features. For example, in one embodiment, a free membership may not create any customized training plans for the user. In addition, the training plans in a free membership may not be based on user activity stored in activity database 130.

Muscular development marketplace 120 may also sell additional third-party exercise programs and/or equipment. Training plans developed by muscular development marketplace 120 may recognize that a member is using one of these third-party programs and/or equipment and specifically design a training plan with small movements that is designed to supplement the third-party program and/or equipment in use. The customized training plans may include various components (e.g., depending on membership level). For example, the training plans may include different variations of exercises which may be more or less effective, include music, motivational quotations, reminder systems, training phases/activities (e.g., endurance, rehabilitation, recovery, etc.). In some embodiments, the music and/or motivational quotations may be selected based on preferences identified by the user. In addition, the music and/or motivational quotations may be further refined and associated with a particular training activity/exercise/movement. For example, during a recovery exercise the music may be softer and more soothing. Similarly, for an endurance routine the music may have more of a strong underlying beat.

In some embodiments, muscular development marketplace 120, may access a calendar associated with the user. Muscular development marketplace 120 may have read only privileges or may have read and write privileges. Using these privileges muscular development marketplace 120 may automatically create entries within the user calendar regarding one or more activities scheduled by the training plan. These entries or links can act as a reminder or indication as to when an exercise is to be performed without interfering with other scheduled obligations. In some embodiments, muscular development marketplace 120 can use entries within the calendar to modify the workout (e.g., length or type of exercises).

Activity database 130 can have a variety of information that can be utilized by muscular development marketplace 120. For example, activity database 130 may have stored thereon information about the user such as, but not limited to, age, contact information, e-mail address, membership level, fitness level, activity logs received from the user, activity logs received from one or more exercise devices 135A-135N associated with the user, and other information. All of this information can be accessed by evaluation engine 140 to evaluate the current fitness level and ability of the user to follow the training plan.

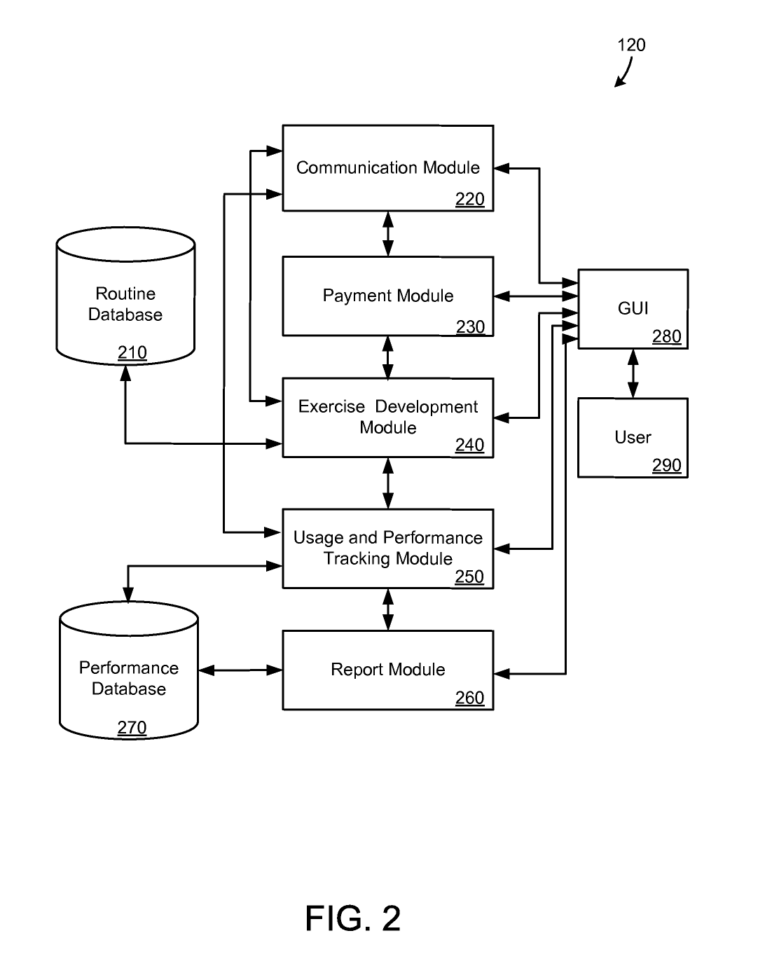

FIG. 2 illustrates a set of components in muscular development marketplace 120 in accordance with one or more embodiments of the present invention. According to the embodiments shown in FIG. 2, muscular development marketplace 120 can include routine database 210, communications module 220, payment module 230, exercise development module 240, usage and performance tracking module 250, report module 260, and performance database 270. Other embodiments of the present invention may include some, all, or none of these modules and components along with other modules, applications, and/or components. Still yet, some embodiments may incorporate two or more of these modules and components into a single module or component and/or associate a portion of the functionality of one or more of these modules or components with a different module or component. For example, in one embodiment, usage and performance tracking module 250 and report module 260 can be combined into a single module for tracking, evaluating, and reporting a recent activity of a user and the user's current fitness level.

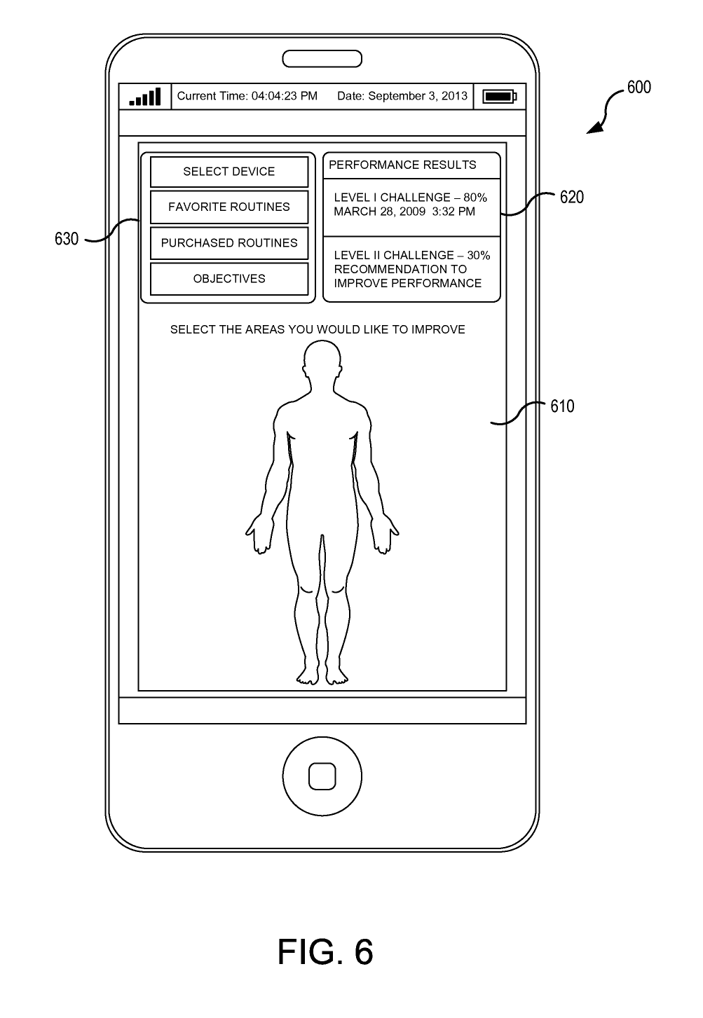

As illustrated in FIG. 2, graphical user interface (GUI) 280 can be used by user 280 to access muscular development marketplace 120. GUI 280 can include one or more GUI screens that allow for interaction with a user of computing system. In at least one embodiment, GUI 280 can allow user 290 to set preferences, make payments, present reports, prioritize fitness goals, and/or otherwise receive or convey information between the user and muscular development marketplace 120. FIG. 6, described in more detail below, illustrates an example a GUI in accordance with one or more embodiments of the present invention.

Routine database 210 can include a variety of exercises and/or movement patterns to target areas of the user's body. The routines may be restricted based on membership level. These routines may be accessed by exercise development module 240 and used to create customized training plans. In some embodiments, communications module 220 can be used to convey the training plans to the user. Communications module 220 can include any type of communications software and/or hardware for communicating with electronic devices.

Payments for the membership levels and/or features (e.g., exercises, videos, etc.) outside of the user's current membership level can be processed through payment module 230. The user's current membership level can be used by exercise development module 240 in selecting which features to include in the plan. Usage of the training plan and user performance can be tracked by usage and performance tracking module 250. Usage and performance module 250 can generate various analytics for presentation using report module 260. These analytics can be generated from user entered data or data received directly from an exercise device and stored in performance database 270.

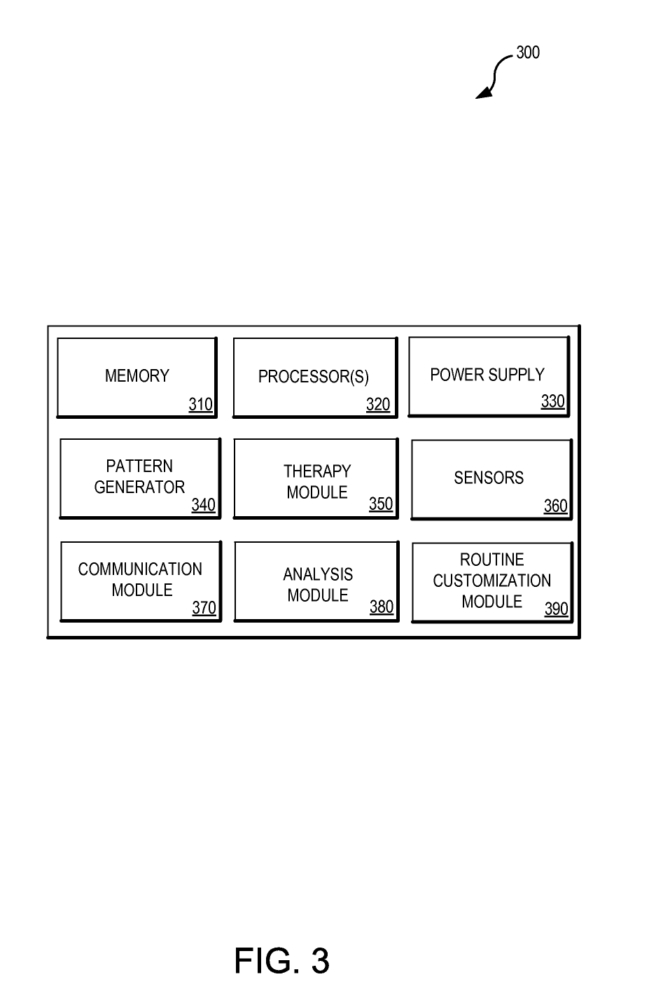

FIG. 3 illustrates a set of components in an exercise device 300 in accordance with various embodiments of the present invention. According to the embodiments shown in FIG. 3, exercise device 300 can include memory 310, one or more processors 320, power supply 330, pattern generator 340, therapy module 350, sensors 360, communication module 370, analysis module 380, and routine customization module 390. Other embodiments of the present invention may include some, all, or none of these modules and components along with other modules, applications, and/or components. Still yet, some embodiments may incorporate two or more of these modules and components into a single module and/or associate a portion of the functionality of one or more of these modules with a different module. For example, in one embodiment, analysis module 380 and routine customization module 390 can be combined into a single module for evaluating a user's ability and developing a customized routine.

Memory 310 can be any device, mechanism, or populated data structure used for storing information. In accordance with some embodiments of the present invention, memory 310 can encompass any type of, but is not limited to, volatile memory, nonvolatile memory and dynamic memory. For example, memory 310 can be random access memory, memory storage devices, optical memory devices, media magnetic media, floppy disks, magnetic tapes, hard drives, SDRAM, RDRAM, DDR RAM, erasable programmable read-only memories (EPROMs), electrically erasable programmable read-only memories (EEPROMs), compact disks, DVDs, and/or the like. In accordance with some embodiments, memory 310 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 310.

Memory 310 may be used to store instructions for running one or more applications or modules on processor(s) 320 powered by power supply 330 (e.g., a battery). For example, memory 310 could be used in one or more embodiments to house all or some of the instructions needed to execute the functionality of pattern generator 340, therapy module 350, sensors 360, communication module 370, analysis module 380, and routine customization module 390.

The training plan generated by the muscular development market place can include one or more patterns that the user should follow as part of their training regime. Various exercise devices can include pattern generator 340 to generate the patterns included in the training plan. In some embodiments, the patterns may be generated through visual indicators (e.g., flashing lights) and/or auditory signals indicating a movement pattern. In other embodiments, pattern generator 340 may use actuators to configure the device for a certain type of exercise. The patterns may be used to develop and/or test neuromuscular coordination, strength, and/or endurance of the user.

Pattern generator 340 may also generate patterns independent of the training plan. For example, pattern generator 340 may include a base set of test patterns to determine a skill and/or fitness level of the user of the exercise device. The pattern may be displayed on the exercise device directly or on another device such as a television or computer screen. Each session with the device may be tracked and recorded. This information may be used by muscular development marketplace when developing the training plan.

Therapy module 350 can be configured to provide various treatments based on algorithm guidelines/instructions put forth by the training plan. For example, therapy module 350 may monitor and/or adjust the temperature being applied to the skin of the user. In other cases, therapy module 350 may also cause various mechanical pulses or various types of auditory therapy as prescribed by the training plan.

Sensors 360 can be included in the exercise device to monitor interactions with the device and the status of the device. Some embodiments of exercise device 300 can include motion sensors, accelerometers, oxygen level sensors, pulse sensors, thermometers, humidity sensors, touch sensors (e.g., capacitive sensors), and other types of sensors to measure the environment, characteristics of the user, and/or interactions between the user and exercise device 300. The information gathered from sensors 360 can be analyzed using analysis module 380. For example, analysis module 380 can determine the user's ability to perform a specific exercise or movement pattern and determine the physiological impact the exercise or movement pattern is having on the user. This information can be communicated, using communication module 370, to routine customization module 390. Routine customization module 390 can locally make adjustments to the training plan generated by muscular development marketplace 120. In some embodiments, some or all of sensors 360 may located externally from the exercise device. For example, sensor 360 may be located in a piece of medical equipment (e.g., blood pressure monitor, a wearable defibrillator, etc.). In other embodiments, the exercise device may interact, or at least receive communications from, external sensors or other devices that include sensors and communications links.

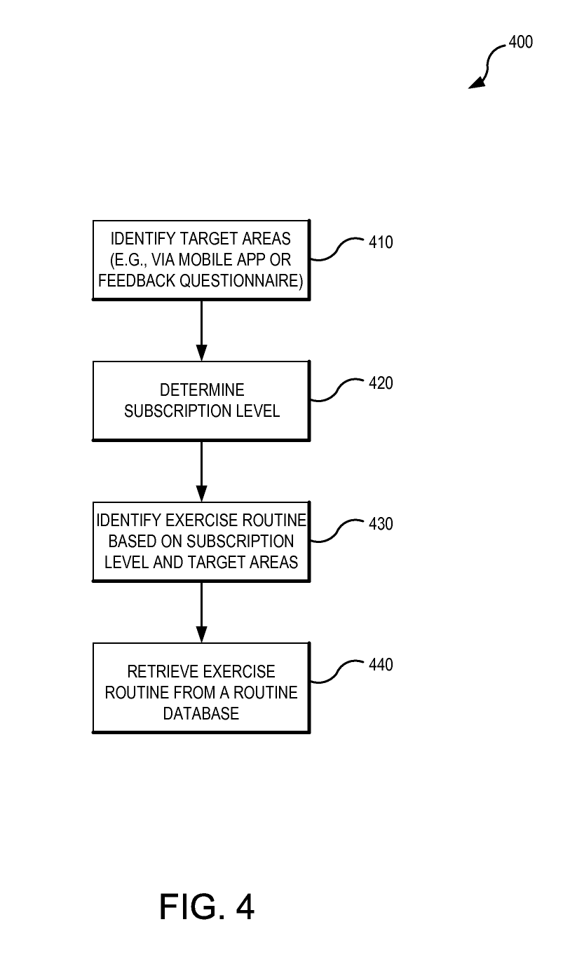

FIG. 4 is a flowchart illustrating a set of operations 400 for identifying and retrieving an exercise routine based on subscription levels and target areas in accordance with one or more embodiments of the present invention. Various operations within this process can be performed, for example, by different modules and/or components such muscular development marketplace 120 shown in FIG. 1. As illustrated in FIG. 4, identification operation 410 identifies target areas that the user would like to develop. In accordance with various embodiments, indications about target areas of interest can be received via a mobile application, feedback questionnaire, or other mechanism. Once muscular development marketplace 120 identifies the target areas, a subscription level of the user can be determined during determination operation 420.

Using the subscription level of the user and the identified target areas, exercise identification operation 430 can identify or create an exercise routine subject to these constraints. Retrieval operation 440 can then retrieve the exercise information from routine database 210. The exercise information may include instructional videos, an ordering of the exercises, instructions for an exercise device, audio files, time ranges for each exercise, progression information, and other types of data and/or information.

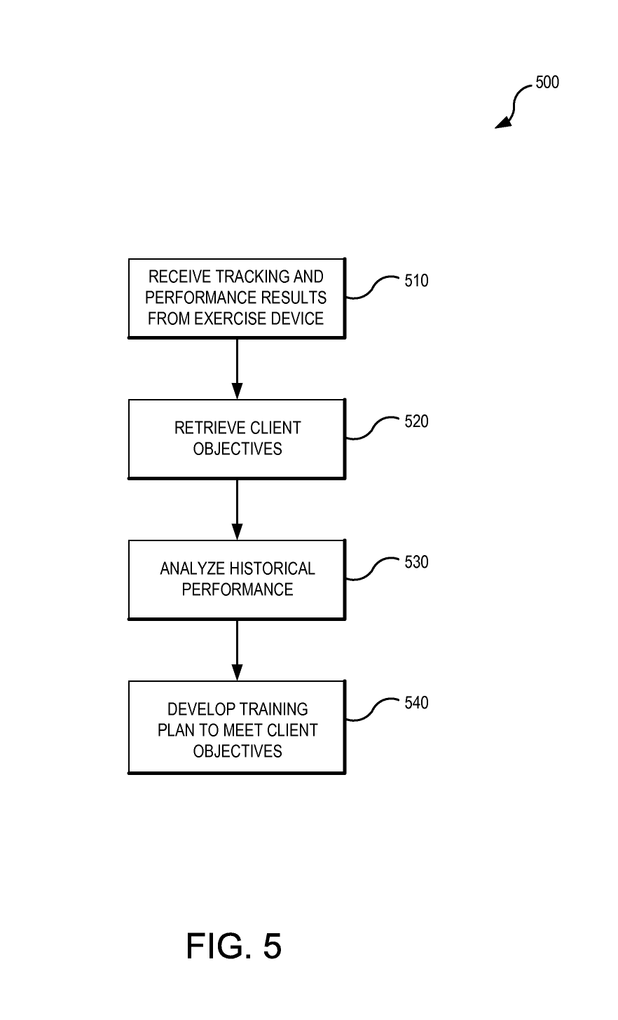

FIG. 5 is a flowchart illustrating a set of operations 500 for developing a training plan in accordance with some embodiments of the present invention. Various operations within this process can be performed, for example, by different modules and/or components such as muscular development marketplace 120 shown in FIG. 1. Receiving operation 510 can receive tracking and performance result from one or more exercise or other electronic devices. These devices can be wearable devices, home use devices (e.g., treadmills, ellipticals, and stationary bikes) and other equipment at the higher end found mostly in gyms. The results may include a variety of data such as amount of weight lifted, distance biked or run, etc. The tracking and performance results may include information collected by sensors 360 during use of the exercise device. In some cases, the tracking and performance results may be manual entries provided by the user or a third-party observer (e.g., a trainer or physician). The results may include all available information (e.g., each data point collected by sensors 360) or may be a set of analytics. In one or more embodiments, for example, the set of analytics may include a statistical summary of various characteristics such as average heart rate, maximum heart rate, minimum hear rate, length of time a movement pattern was performed, ability of the user to follow the desired movement pattern, average temperature, maximum strength or pressure recorded, and the like.

Retrieval operation 520 retrieves a set of client objectives. The objectives may be specific quantitative objectives, qualitative objectives, and/or a combination thereof. Once these objectives are retrieved, analysis operation 530 analyzes the historical performance in view of these objectives. Using the results of this analysis a training plan can be developed using development operation 540 that will guide the user closer to the desired objectives. In some cases, other inputs from the user may be used in creating the plan. For example, the user may specify the number of days and/or the amount of time the user has to perform the exercises/movement patterns in the training plan.

FIG. 6 illustrates a graphical user interface 600 which may be used in accordance with one or more embodiments of the present invention. Graphical user interface 600 includes various buttons and fields that allow a user to customize and review their training program. For example, in a region 610 the user select which areas of the body the user would like to target. Depending on the subscription level, specific muscles may or may not be available for targeting or isolated targeting. Once the user selects the desired areas of the body in region 610, this information can be conveyed to muscular development marketplace 120 where a customized training plan can be generated.

In a region 620, the user may review performance results provided by an exercise device and/or muscular development marketplace 120. In region 620, buttons allow the user to select an exercise device, favorite routines, purchased routines, and set additional objectives (e.g., speed, flexibility, coordination, balance, etc.). In some embodiments, selection of one of these buttons may result the application navigating to new page. In other embodiments, selection of one of the buttons may produce one or more drop down menus allowing the user to select available features.

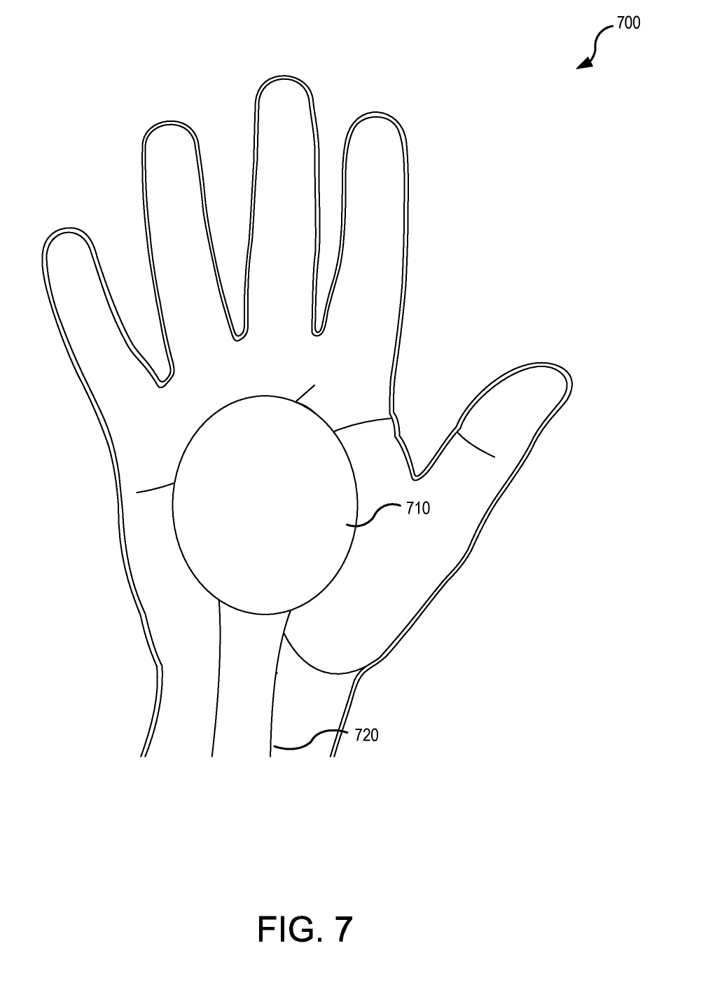

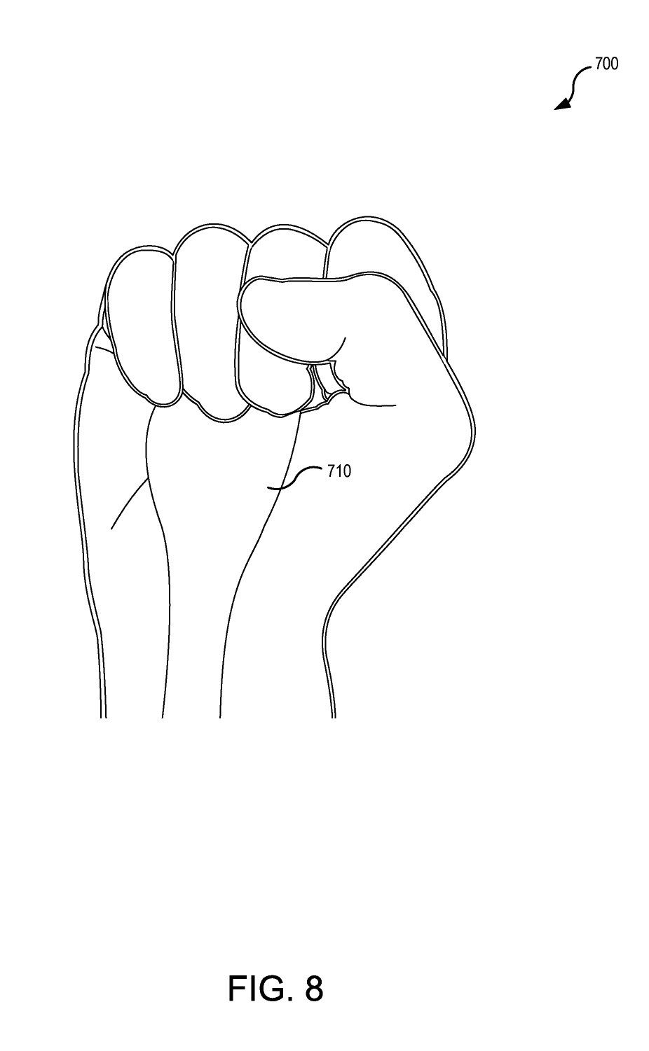

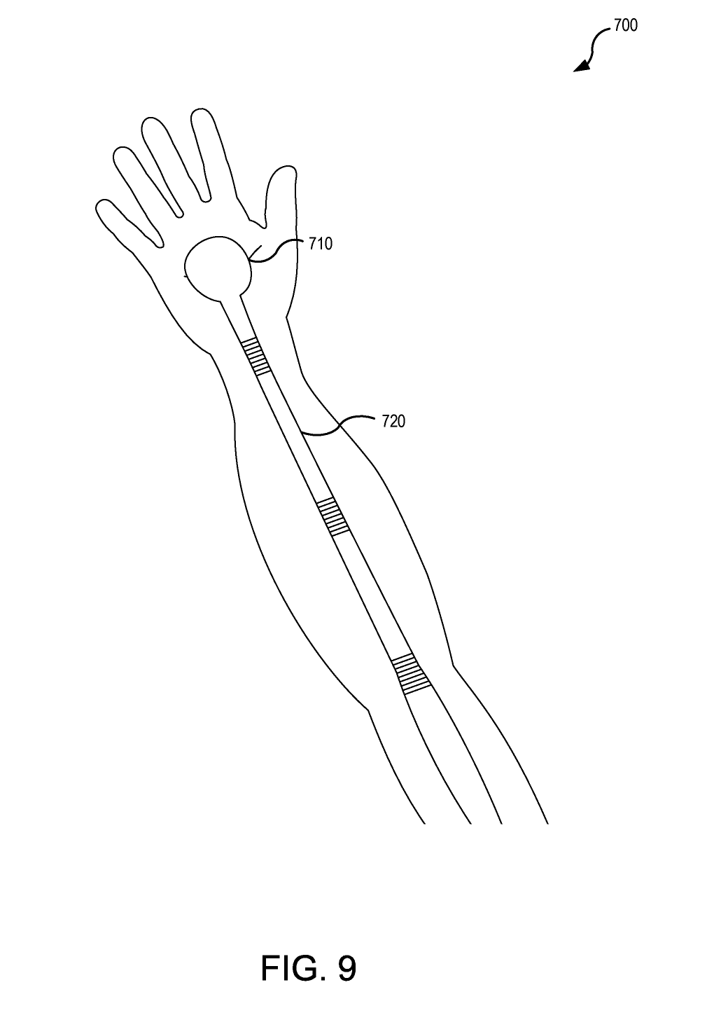

FIGS. 7-9 illustrate the use of upper body and hand exercise device 700 in accordance with some embodiments of the present invention. Hand exercise device 700 can include a soft, malleable section 710 which can be squeezed by the hand of a user. Malleable section 710 may be in the shape of a sphere, half sphere, ovoid, or customized shape in order to position the hand for a small movement exercise provided by the training plan. Malleable section 710 allows for an exogenous resistance to be added to the movement pattern of the fingers specified by the training plan. Upper body and hand exercise device 700 may or may not have any electronics as described in FIG. 3. Upper body and hand exercise device 700 may not only have sensors for detecting an amount of persistence, conductivity, amount of pressure/resistance, but also output devices like lights or other visual indicators, sound indicators, or force feedback to cause vibrations. Using these sensors and output devices, upper body and hand exercise device 700 can train a user to use the specific small muscles. As such, several embodiments include various mechanisms for providing positive or negative reinforcement to the user as to when they are properly using the small muscles.

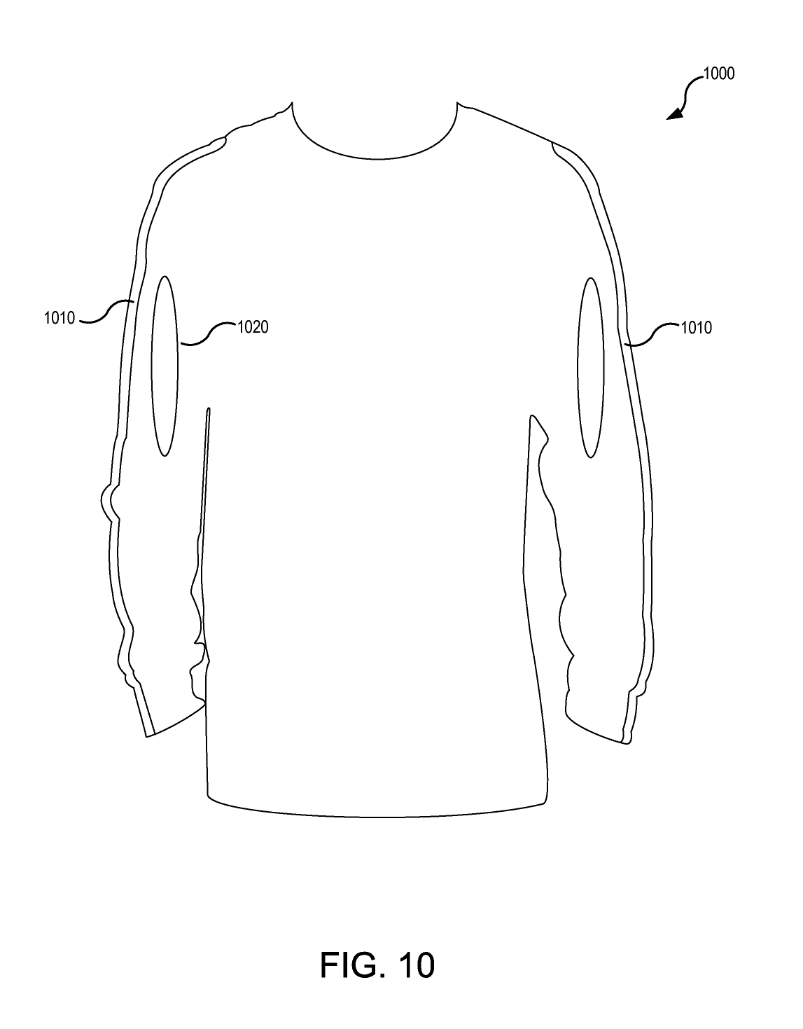

In addition to malleable section 710, hand exercise device 700 may also include extendable member 720 to position the wrist and/or arm of the user in a desired position. In some embodiments, extendable member 720 may be more rigid than malleable section 710 and include one or more securing mechanisms such as a strap to secure extendable member 720 to the user's wrist and/or arm. In other embodiments, an article of clothing such as shirt 1000 illustrated in FIG. 10 may be used to position hand and upper body exercise device 700. For example, as illustrated in FIG. 10, shirt 1000 may include pockets or slits 1010 in which extendable member 720 is designed to fit. In accordance with some embodiments, shirt 1000 may be form fitting and/or have one or more sections 1020 designed to apply pressure or resistance to various muscles of the user.

In accordance with various embodiments, extendable member 720 may be fixed or have a plurality of preset positions. In addition, in some embodiments, extendable member 720 may be permanently affixed to or removable from malleable section 710. The specific settings may be specified by the training plan provided by muscular development marketplace 120. In some cases, a video and/or text may be provided to the user that illustrates the desired motion and device configuration for the exercise.

In some embodiments, the firmness of malleable section 710 may be automatically adjusted using an air pump, electric current, or other mechanism. Various properties of malleable section 710 may be adjusted using a smart phone. In some cases, a user's smart phone, computer, or other electronic device (e.g., a gaming console) could provide a particular training program that dynamically adjusts the malleability of the object during the routine, to make it easy during an initial warm-up period, followed by greater firmness during the middle portion of the workout.

Similarly, extendable member 720 may include one or more actuators for adjusting angles and/or lengths of the device. The instructions for adjusting the firmness of malleable section 710 and/or the angles and/or lengths of extendable member 720 may be received in real-time or near real-time from a separate device (e.g., a mobile phone) or muscular development marketplace 120. In other embodiments, the instructions may be downloaded to hand exercise device 700 prior to the beginning of the exercise or movement pattern.

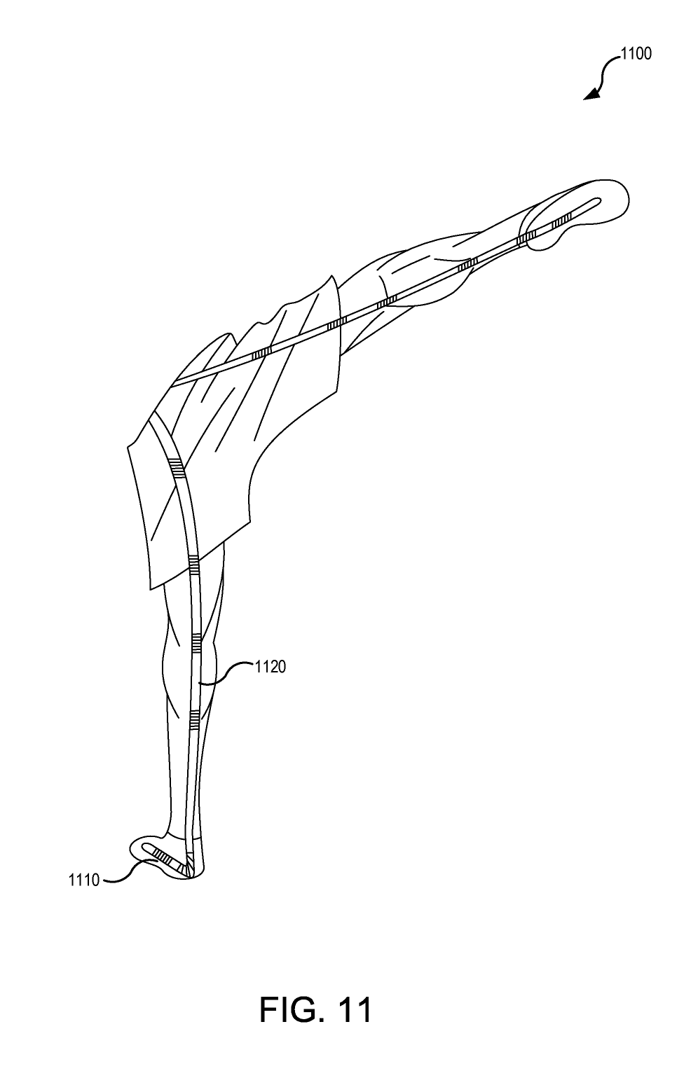

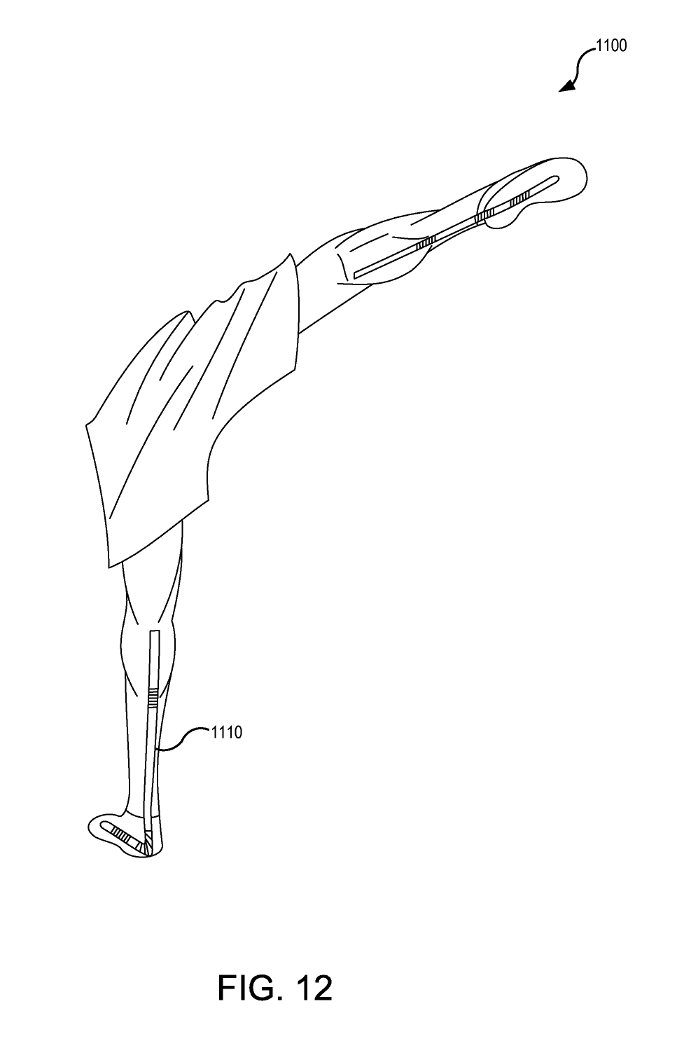

FIGS. 11-12 illustrate a lower body exercise device 1100 which may be used in accordance with various embodiments of the present invention. Similar to upper body and hand exercise device 700, lower body exercise device 1100 can include a soft, malleable section 1110 on which the user can stand. Malleable section 1110 may be in the shape of a sphere, half sphere, or other shape in order to position the foot for a small movement exercise provided by the training plan. Malleable section 1110 allows for pressure to be added to various portions of the bottom of the user foot during the movement pattern specified by the training plan. Lower body exercise device 1100 may or may not have any electronics as described in FIG. 3.

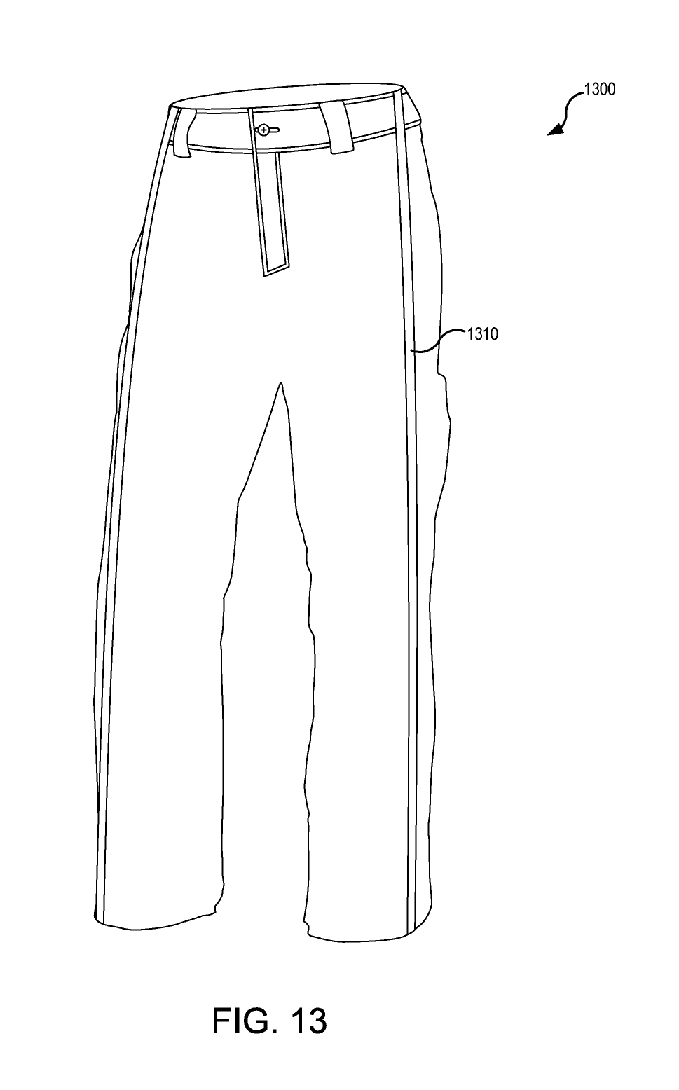

In addition to malleable section 1110, lower body exercise device 1100 may also include extendable member 1120 to position the ankle and/or leg of the user in a desired position. In some embodiments, extendable member 1120 may be more rigid than malleable section 1110 and include one or more securing mechanism such as a strap to secure extendable member 1120 to the user's ankle and/or leg. In other embodiments, an article of clothing such as pants 1300 illustrated in FIG. 13 may be used to position lower body exercise device 1100. For example, as illustrated in FIG. 13, pants 1300 may include slits 1310 in which extendable member 1120 is designed to fit.

In accordance with various embodiments, extendable member 1120 may be fixed or have a plurality of preset positions. In addition, in some embodiments, extendable member 1120 may be permanently affixed to or removable from malleable section 1110. The specific settings may be specified by the training plan provided by muscular development marketplace 120. In some cases, a video and/or text may be provided (e.g., through a mobile application or user interface associated with an exercise device) illustrating the desired motion and device configuration for the exercise.

In some embodiments, the firmness of malleable section 1110 may be automatically adjusted using an air pump or other mechanism. Similarly, extendable member 1120 may include one or more actuators for adjusting angles and/or lengths of the device. The instructions for adjusting the firmness of malleable section 1110 and/or the angles and/or lengths of extendable member 1120 may be received in real-time or near real-time from a separate device (e.g., a mobile phone) or muscular development marketplace 120. In other embodiments, the instructions may be downloaded to lower body exercise device 1100 prior to the beginning of the exercise or movement pattern.

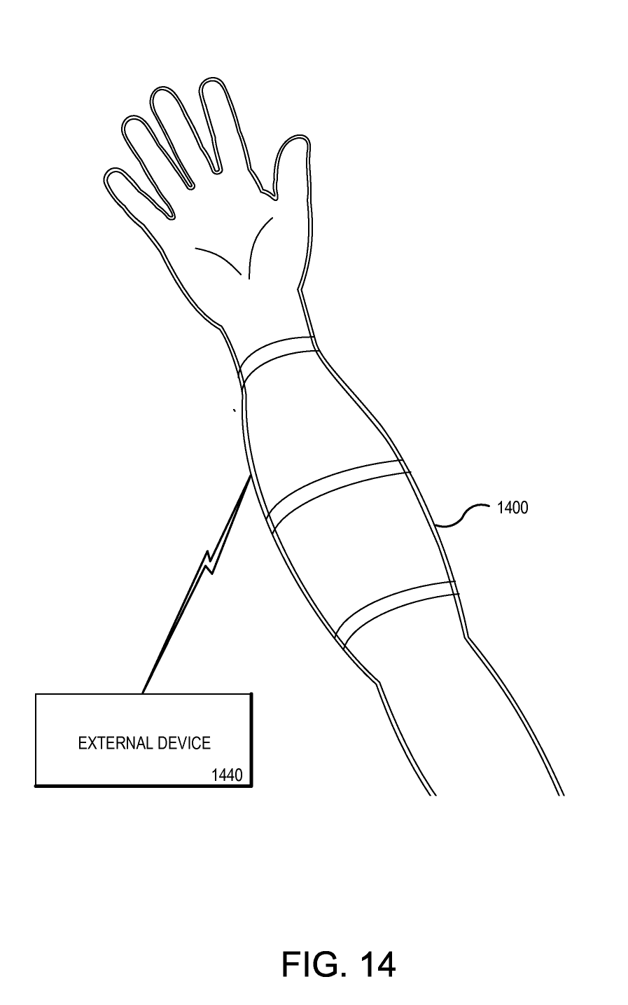

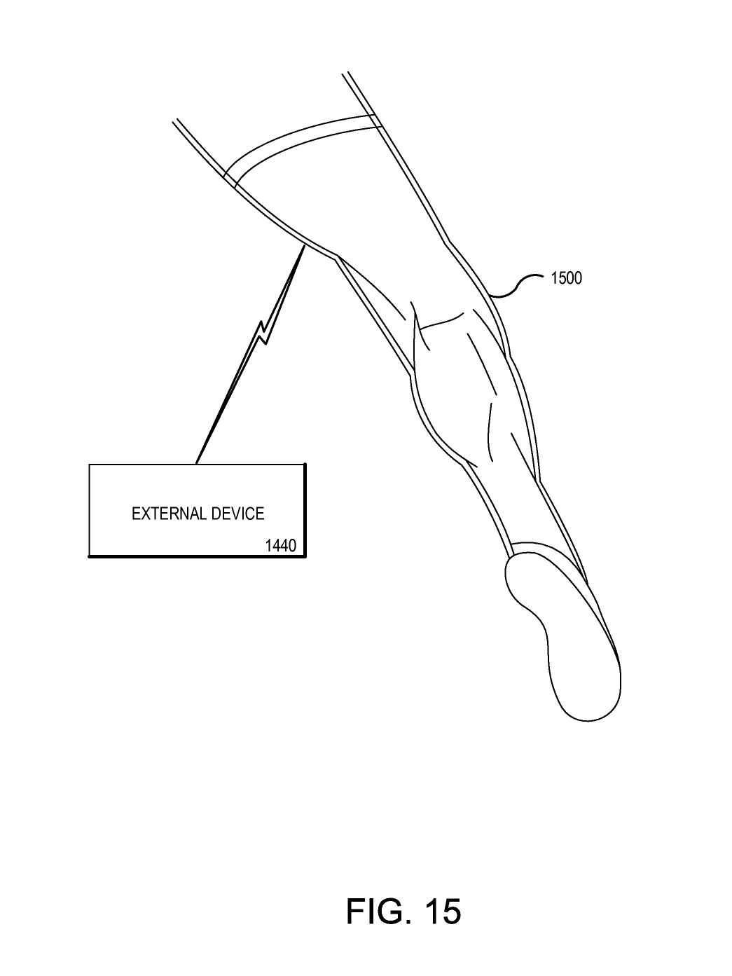

FIGS. 14-15 illustrate an arm covering or glove 1400 and a leg covering 1500, respectively, both of which may be used in accordance with one or more embodiments of the present invention. Both arm covering or glove 1400 and leg covering 1500 may or may not have any electronics as described in FIG. 3. For example, coverings 1400 and 1500 may include accelerometers and/or other sensors to monitor the movement of the user. These sensors can allow the user to interact in real-time with external device 1410. External device can be, for example, a computer, mobile device, a gaming console, or other electronic device capable of receiving signals from the coverings.

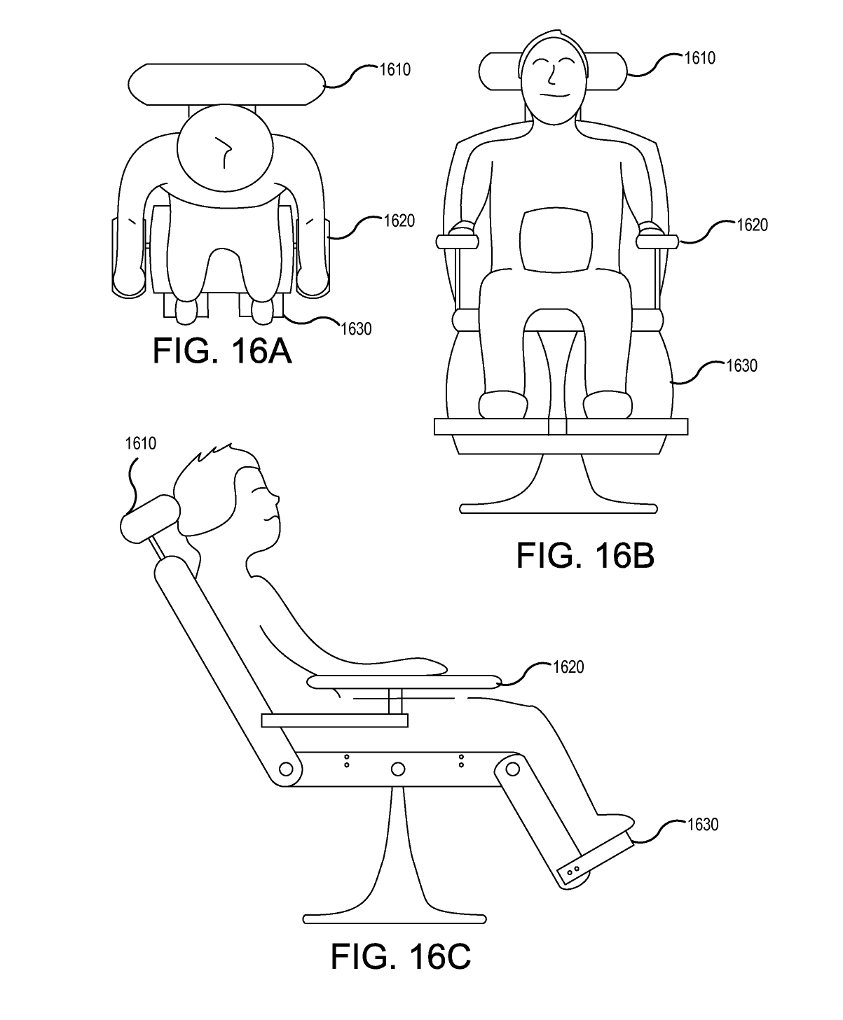

FIGS. 16A-16C illustrate a top, front, and side view of a chair which may be used in accordance various embodiments of the present invention. The chair illustrated in FIGS. 16A-16C may include multiple actuators that allow head rest 1610, arm rest 1620, leg rest 1630, and/or other parts of the chair to be automatically configured for various exercises and/or movement patterns set forth by a training plan received from muscular marketplace 120. In some embodiments, the firmness of the chair may also be adjusted. For example, leg rest 1630 may include one or more malleable sections which the user can place his foot upon. Leg rest 1630 may include a foot rest that designed to allow a user to flex their toes overtop of an upper portion. In various embodiments, leg rest 1630 and arm rest 1620 may move freely around one or more pivot points to allow the user to rotate and configure their legs and arms in multiple positions. In some embodiments, the chair may provide continuous motions (e.g., of the hands or feet).

Various embodiments of the chair may include one or more of the following features: 1) guards on each side of a foot rest; 2) multiple pivot points which can allow each joint of the user to be moved or flexed; 3) actuators for the multiple pivot points; 4) ability to apply variable pressure on different points of the user; 5) contoured to a user's body; and 6) allow other exercise devices to integrate seamlessly (e.g., upper body and hand exercise device 700 or hand exercise devices 1700 and 1800). Some embodiments of the chair may also include a television or computing device that is able to provide instructions for movements and/or muscle contractions the user should make while sitting in the chair.

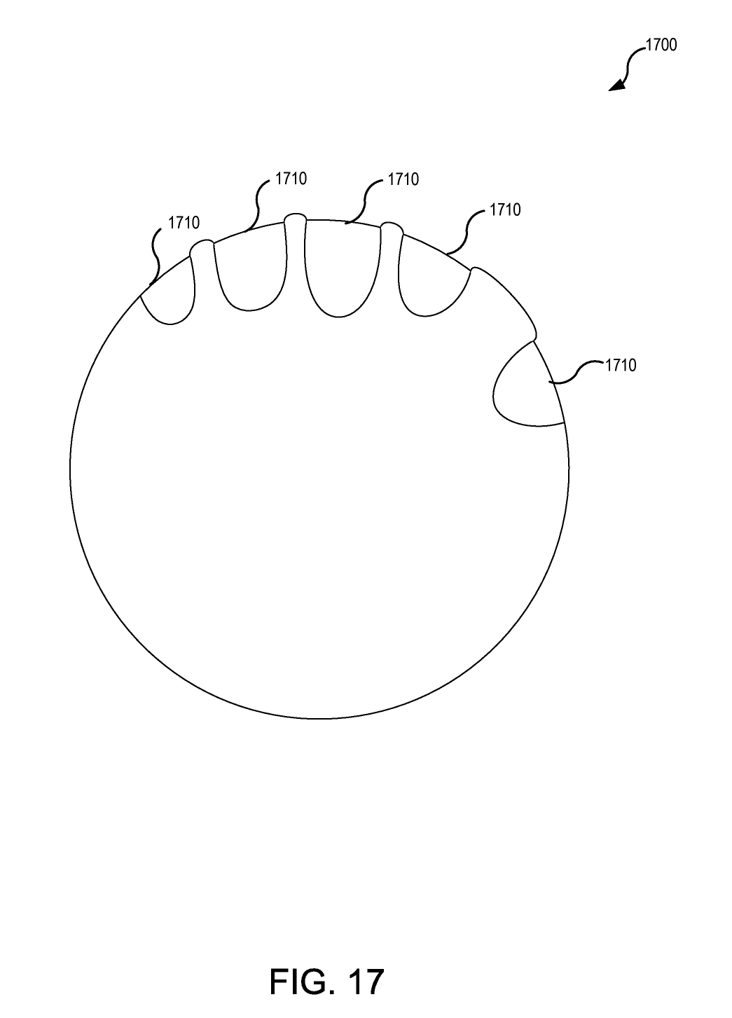

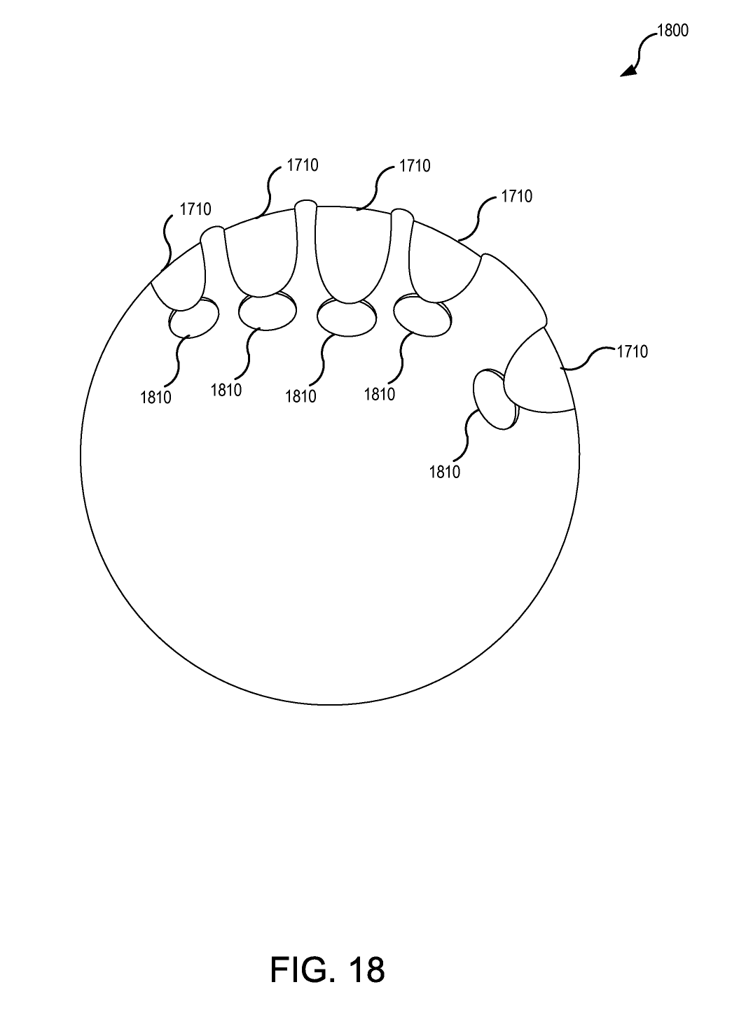

FIGS. 17-18 illustrate examples of hand exercise devices 1700 and 1800 which may be used in accordance with one or more embodiments of the present invention. Hand exercise devices 1700 and 1800 may be a compressible ball having a set of finger grips or grooves 1710 to properly align the fingers of a user for various small movement exercises. Hand exercise devices 1700 and 1800 may have a spherical, ovoid, or other shape or contour that allows for proper positioning of the user's hand in order to activate various muscles. In some embodiments, hand exercise devices 1700 and 1800 may have like a gel coating or other material that would make it comfortable. Hand exercise devices 1700 and 1800 may also be collapsible for easy storage and transport.

As illustrated in FIG. 18, some embodiments of hand exercise device 1800 may also include openings 1810 in which the fingers of a user can be inserted. The openings may have various types of inserts (e.g., a gel-like insert) to provide comfort and resistance during one or more movement patters. The inserts may be removable or permanently affixed within the openings. In some cases, the opening may have a floating-type structure that allows fingers to experience a wider range of movement. The floating like structure may be attached to the opening using springs or some type of band.

In some embodiments, the floating-like structure can provide active resistance by changing positions and/or angles with respect to the user's fingers (e.g., by using an actuator). For example, hand exercise device 1800 may move the user's fingers (e.g., as a group or each one individually) in various motions (e.g., in a circle). By manipulating the smaller muscles, these hand exercise devices affect the larger muscles. Still yet, in some embodiments, hand exercise device 1800 may include one or more extensions (e.g., spring loaded flaps or push outs) which can move the hand/fingers in various directions.

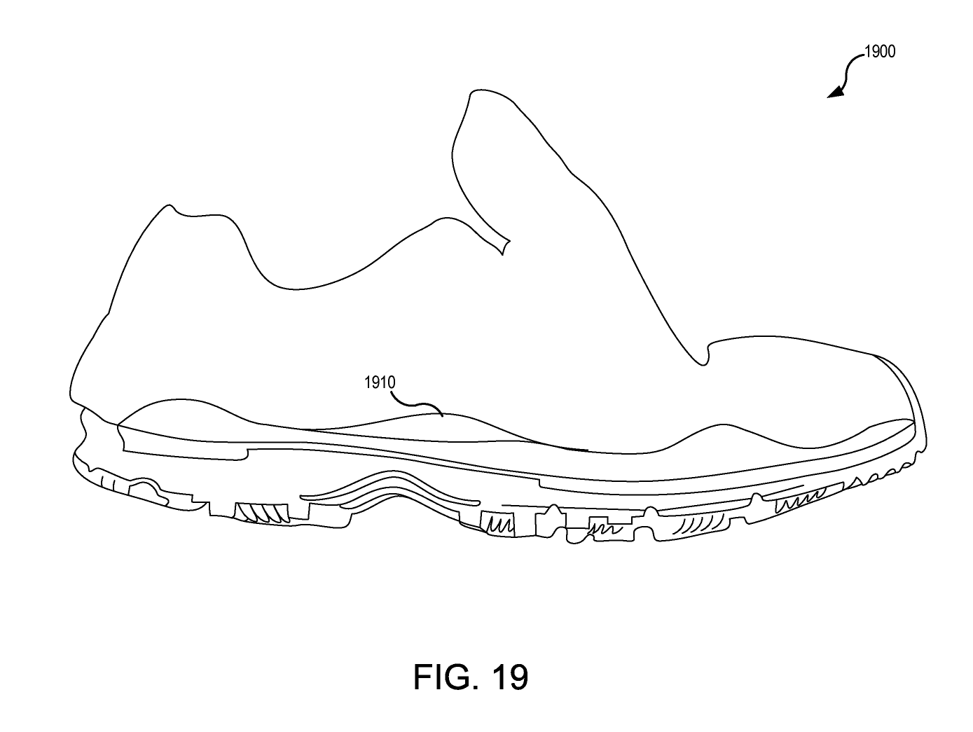

FIG. 19 illustrates a shoe 1900 which may be used in accordance with various embodiments of the present invention. As illustrated in shoe 1900, it may include an insole 1910 designed to place the user's foot in a desired position in order to target the smaller muscle groups of the foot during exercises or movement patterns set forth by the training plan.

### Exemplary Computer System Overview

Aspects and implementations of the muscular development system of the disclosure have been described in the general context of various steps and operations. A variety of these steps and operations may be performed by hardware components or may be embodied in computer-executable instructions, which may be used to cause a general-purpose or special-purpose processor (e.g., in a computer, server, or other computing device) programmed with the instructions to perform the steps or operations. For example, the steps or operations may be performed by a combination of hardware, software, and/or firmware.

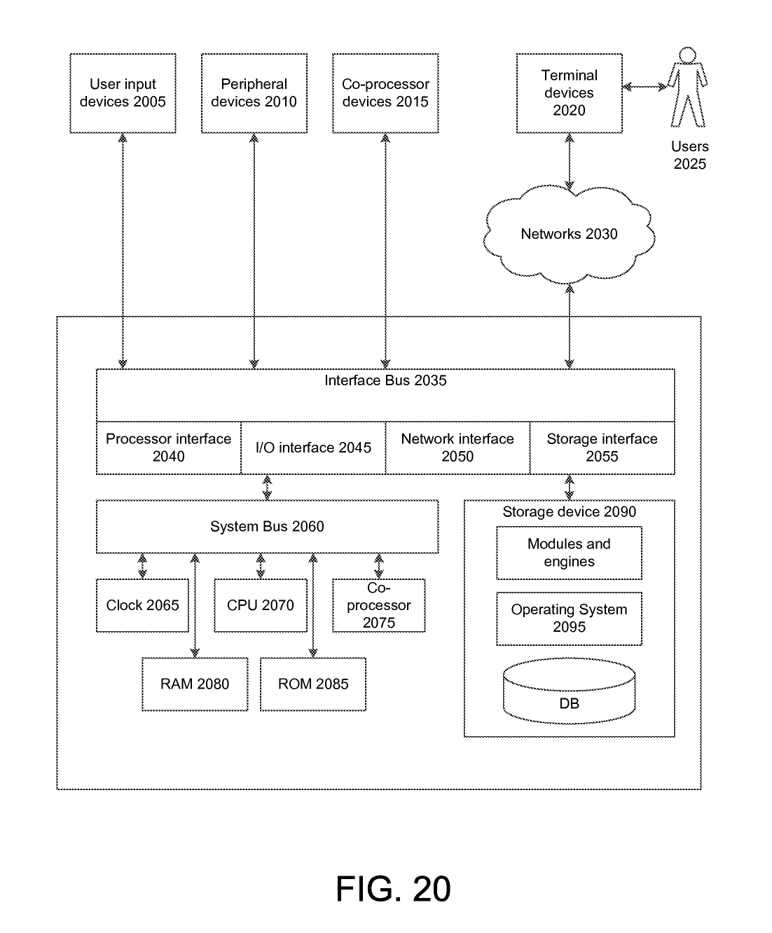

FIG. 20 is a block diagram illustrating an example machine representing the computer systemization of the muscular development marketplace 120. The muscular development marketplace 120 may be in communication with entities including one or more users 2025 (e.g., human and non-human users, financial institutions), client/terminal devices 2020 (e.g., devices 110A-110N), user input devices 2005, peripheral devices 2010, an optional co-processor device(s) (e.g., cryptographic processor devices) 2015, and networks 2030 (e.g., network 115). Users may engage with the muscular development marketplace 120 via terminal devices 2020 over networks 2030.

Computers may employ central processing unit (CPU) or processor (hereinafter “processor”) to process information. Processors may include programmable general-purpose or special-purpose microprocessors, programmable controllers, application-specific integrated circuits (ASICs), programmable logic devices (PLDs), embedded components, combination of such devices and the like. Processors execute program components in response to user and/or system-generated requests. One or more of these components may be implemented in software, hardware or both hardware and software. Processors pass instructions (e.g., operational and data instructions) to enable various operations.

Muscular development marketplace 120 may include clock 2065, CPU 2070, memory such as read only memory (ROM) 2085 and random access memory (RAM) 2080, and co-processor 2075 among others. These controller components may be connected to a system bus 2060, and through the system bus 2060 to an interface bus 2035. Further, user input devices 2005, peripheral devices 2010, co-processor devices 2015, and the like, may be connected through the interface bus 2035 to the system bus 2060. The interface bus 2035 may be connected to a number of interface adapters such as processor interface 2040, input/output interfaces (I/O) 2045, network interfaces 2050, storage interfaces 2055, and the like.

Processor interface 2040 may facilitate communication between co-processor devices 2015 and co-processor 2075. In one implementation, processor interface 2040 may expedite encryption and decryption of requests or data. Input/output interfaces (I/O) 2045 facilitate communication between user input devices 2005, peripheral devices 2010, co-processor devices 2015, and/or the like and components of the muscular development marketplace 120 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 2050 may be in communication with the network 2030. Through the network 2030, muscular development marketplace 120 may be accessible to remote terminal devices 2020 (e.g., client devices 110A-110N). Network interfaces 2050 may use various wired and wireless connection protocols such as, direct connect, Ethernet, wireless connection such as IEEE 802.11a-x, and the like.

Examples of network 2030 include the Internet, Local Area Network (LAN), Metropolitan Area Network (MAN), a Wide Area Network (WAN), wireless network (e.g., using Wireless Application Protocol (WAP)), a secured custom connection, and the like. The network interfaces 2050 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including, for example, the access and operation rights of an object by an individual, a machine, and/or an application, and the circumstances under which the permission rights stand. Other network security functions performed or included in the functions of the firewall, can be, for example, but are not limited to, intrusion-prevention, intrusion detection, next-generation firewall, personal firewall, etc., without deviating from the novel art of this disclosure.

Storage interfaces 2055 may be in communication with a number of storage devices such as, storage devices 2090, removable disc devices, and the like. The storage interfaces 2055 may use various connection protocols such as Serial Advanced Technology Attachment (SATA), IEEE 1394, Ethernet, Universal Serial Bus (USB), and the like.

User input devices 2005 and peripheral devices 2010 may be connected to I/O interface 2045 and potentially other interfaces, buses and/or components. User input devices 2005 may include card readers, finger print readers, joysticks, keyboards, microphones, mouse, remote controls, retina readers, touch screens, sensors, and/or the like. Peripheral devices 2010 may include antenna, audio devices (e.g., microphone, speakers, etc.), cameras, external processors, communication devices, radio frequency identifiers (RFIDs), scanners, printers, storage devices, transceivers, and/or the like. Co-processor devices 2015 may be connected to muscular development marketplace 120 through interface bus 2035, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The muscular development marketplace 120 may employ various forms of memory including on-chip CPU memory (e.g., registers), RAM 2080, ROM 2085, and storage devices 2090. Storage devices 2090 may employ any number of tangible, non-transitory storage devices or systems such as fixed or removable magnetic disk drive, an optical drive, solid state memory devices and other processor-readable storage media. Computer-executable instructions stored in the memory may include the muscular development systems having one or more program modules such as routines, programs, objects, components, data structures, and so on that perform particular tasks or implement particular abstract data types. For example, the memory may contain operating system (OS) component 2095, modules and other components, database tables, and the like. These modules/components may be stored and accessed from the storage devices, including from external storage devices accessible through an interface bus.

The database components can store programs executed by the processor to process the stored data. The database components may be implemented in the form of a database that is relational, scalable and secure. Examples of such database include DB2, MySQL, Oracle, Sybase, and the like. Alternatively, the database may be implemented using various standard data-structures, such as an array, hash, list, struct, structured text file (e.g., XML), table, and/or the like. Such data-structures may be stored in memory and/or in structured files.

Muscular development marketplace 120 may be implemented in distributed computing environments, where tasks or modules are performed by remote processing devices, which are linked through a communications network, such as a Local Area Network (LAN), Wide Area Network (WAN), the Internet, and the like. In a distributed computing environment, program modules or subroutines may be located in both local and remote memory storage devices. Distributed computing may be employed to load balance and/or aggregate resources for processing. Alternatively, aspects of muscular development marketplace 120 may be distributed electronically over the Internet or over other networks (including wireless networks). Those skilled in the relevant art will recognize that portions of the muscular development systems may reside on a server computer, while corresponding portions reside on a client computer. Data structures and transmission of data particular to aspects of the muscular development marketplace 120 are also encompassed within the scope of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a computer-readable medium claim, other aspects may likewise be embodied as a computer-readable medium claim, or in other forms, such as being embodied in a means-plus-function claim. (Any claims intended to be treated under 35 U.S.C. §112, 1¶ will begin with the words “means for”, but use of the term “for” in any other context is not intended to invoke treatment under 35 U.S.C. §112, 1¶.) Accordingly, the applicant reserves the right to pursue additional claims after filing this application to pursue such additional claim forms, in either this application or in a continuing application.

What is claimed is:

1. A computer-implemented method comprising:
receiving, via a communications network, current performance results of a client that were recorded at an exercise device having a set of sensors,
wherein the current performance results include an indication of a physiological impact the exercise device had on the client during exercise as recorded by the set of sensors;
retrieving, from a database, historical performance results, a membership level, and a set of client objectives associated with the client,
wherein the set of client objectives identify a body area to target and at least one goal that includes neuromuscular coordination, strength, endurance, recovery, or rehabilitation for the body area;
analyzing, using a processor, the historical performance results and the current performance results; and
generating, using the processor, a customized training plan having at least one small movement exercise designed to manipulate smaller muscle groups to compound the effects on larger muscles in accordance with the at least one goal,
wherein the customized training plan includes instructions for operation of the exercise device;
wherein the customized training plan is dependent on the membership level of the client; and
wherein the customized training plan is designed to meet the set of client objectives based on the historical performance results and the current performance results.

2. The computer-implemented method of claim 1, further comprising transmitting the customized training plan to the exercise device.

3. The computer-implemented method of claim 2, wherein the exercise device generates one or more patterns based on the instructions for operation of the exercise device included in the customized training plan.

4. The computer-implemented method of claim 1, further comprising generating a graphical user interface having a first screen that allows the client to select objectives and target areas of the customized training plan.

5. The computer-implemented method of claim 4, wherein the graphical user interface screen has a second screen that presents the historical performance results and the current performance results to the client.

6. The computer-implemented method of claim 5, wherein the graphical user interface screen has a third screen that allows the client to select musical preferences, and the computer-implemented method further comprising selecting music consistent with the musical preferences of the client and adding the music in the customized training plan.

7. The computer-implemented method of claim 1, wherein the exercise device records an attempt by the client to perform exercises within the customized training plan and modifies the customized training plan based on the attempt.

8. A system comprising:
an activity database have stored thereon a plurality of activity tracking entries received from one or more exercise devices associated with a client;
an evaluation engine to generate a development report based on the activity tracking entries stored in the activity database; and
a muscular development marketplace running on a server, wherein the muscular development market place is configured to receive the development report from the evaluation engine and develop a training plan based on the development report and the one or more exercise devices associated with the client,
wherein the training plan developed by the muscular development marketplace has at least one small movement exercise designed to manipulate smaller muscle groups to compound the effects on larger muscles.

9. The system of claim 8, wherein the training plan includes a video illustrating how to perform an exercise.

10. The system of claim 8, wherein the muscular development marketplace includes a graphical user interface generation module configured to generate a graphical user interface screen allowing the client to identify objectives and target areas.

11. The system of claim 10, wherein the muscular development marketplace includes a routine database and an exercise development module, the routine database having stored thereon multiple base routines which can be accessed and modified by the exercise development module to comply with the objectives and target areas identified by the client.

12. The system of claim 8, wherein the muscular development marketplace includes a payment module configured to process payments from the client, wherein the payments are for a membership level within the muscular development marketplace.

13. The system of claim 8, wherein the exercise devices include sensors to measure strength and track movement of the client.

14. The system of claim 8, wherein the one or more exercise devices include:
a processor;
a communication module configured to receive the training plan from the muscular development marketplace, wherein the training plan includes a movement pattern;
a pattern generator configured to generate, using the processor, the movement pattern included in the training plan; and
a sensor configured to track responses of the client to the movement pattern.

15. The system of claim 8, wherein the muscular development marketplace includes a report module configured to estimate a fitness level based on the plurality of activity tracking entries received from the one or more exercise devices associated with the client.

16. The system of claim 8, wherein the muscular development marketplace determines a subscription level of the client and develops the training plan based on the subscription level.

17. A non-transitory computer-readable medium containing instructions that, when executed by a computer system, cause the computer system to:
receive current performance results of a client that were recorded at an exercise device;
retrieve, from a database, historical performance results and a set of client objectives associated with the client;
analyze the historical performance results and the current performance results; and
generate a training plan for the client designed to meet the set of client objectives based on the historical performance results and the current performance results.

18. The non-transitory computer-readable medium of claim 17, wherein the instructions, when executed by the computer system, further cause the computer system to transmit the training plan to the exercise device.

19. The non-transitory computer-readable medium of claim 17, wherein the instructions, when executed by the computer system, further cause the computer system to generate a graphical user interface having a first screen that allows the client to select objectives and target areas of the training plan and a second screen that presents the historical performance results and the current performance results to the client.

20. The non-transitory computer-readable medium of claim 17, wherein the training plan generated is dependent on a membership level of the client.
